(19) United States
(12) Patent Application Publication
(10) Pub. No.: US 2016/0018282 A1
(43) Pub. Date: Jan. 21, 2016

(54) Refrigerant Leak Locating Device

(71) Applicant: Moshen Kimyae, San Diego, CA (US)

(72) Inventor: Moshen Kimyae, San Diego, CA (US)

(21) Appl. No.: 14/335,591

(22) Filed: Jul. 18, 2014

(51) Int. Cl. G01M 3/22; F16L 41/00; F16L 41/04

(52) U.S. Cl. CPC G01M 3/22; F16L 41/045; F16L 41/008

(57) ABSTRACT

A refrigerant leak locating device taps into and distributes a dye into a refrigerant line to facilitating locating a leak in the refrigerant line. The device includes a housing having a first section selectively separable from a second section. Each of a pair of channels extends into a respective one of the first section and the second section. The channels are aligned defining a conduit through the housing. A screw has a pointed end extendable into the conduit when the screw is fully inserted into the housing wherein the pointed end pierces a refrigerant line positioned in the conduit. A tube extends into the housing having a first end is in fluid communication with the conduit. A dye is positioned in the tube wherein the dye is introduced into the refrigerant line when the pointed end of the screw pierces the refrigerant line.

### BACKGROUND OF THE DISCLOSURE

### Field of the Disclosure

The disclosure relates to leak locating devices and more particularly pertains to a new leak locating device for tapping into and distributing a dye into a refrigerant line to facilitating locating a leak in a refrigerant line.

### SUMMARY OF THE DISCLOSURE

An embodiment of the disclosure meets the needs presented above by generally comprising a housing having a first section selectively separable from a second section. Each of a pair of channels extends into a respective one of the first section and the second section. The channels are aligned defining a conduit through the housing. A screw has a pointed end extendable into the conduit when the screw is fully inserted into the housing wherein the pointed end pierces a refrigerant line positioned in the conduit. A tube extends into the housing having a first end is in fluid communication with the conduit. A dye is positioned in the tube wherein the dye is introduced into the refrigerant line when the pointed end of the screw pierces the refrigerant line.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a partially exploded top front side perspective view of a refrigerant leak locating device according to an embodiment of the disclosure.

FIG. 2 is a top front side perspective view of an embodiment of the disclosure.

FIG. 3 is a bottom view of an embodiment of the disclosure.

FIG. 4 is a partial cut-away side view of an embodiment of the disclosure.

FIG. 5 is a top front side perspective view of an embodiment of the disclosure in use.

### DESCRIPTION OF THE PREFERRED EMBODIMENT

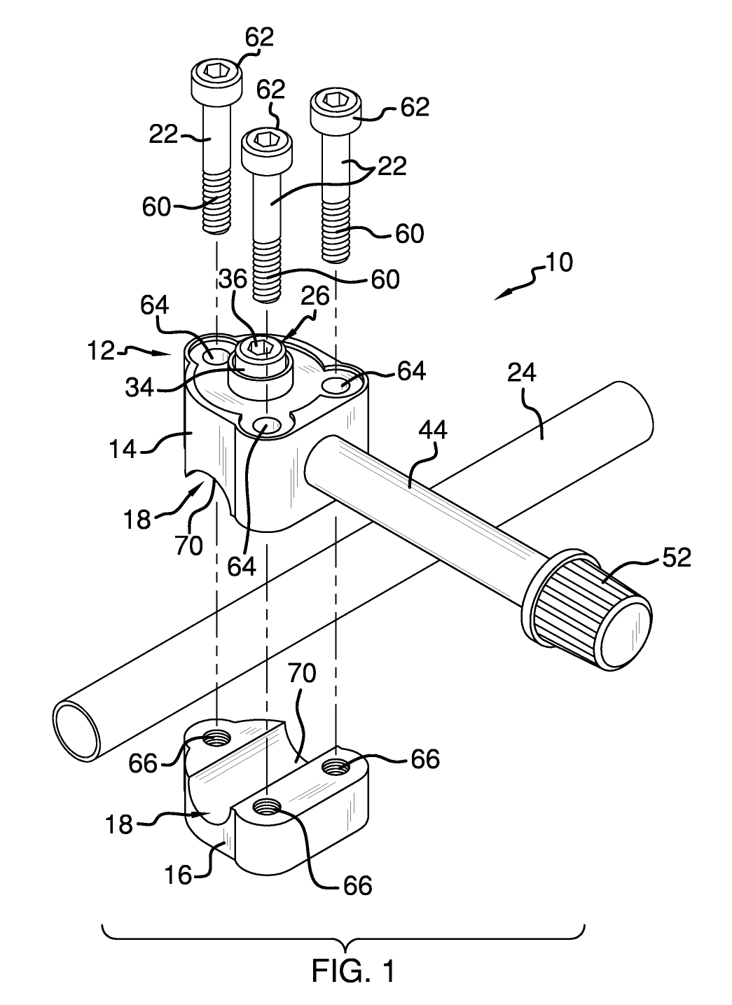

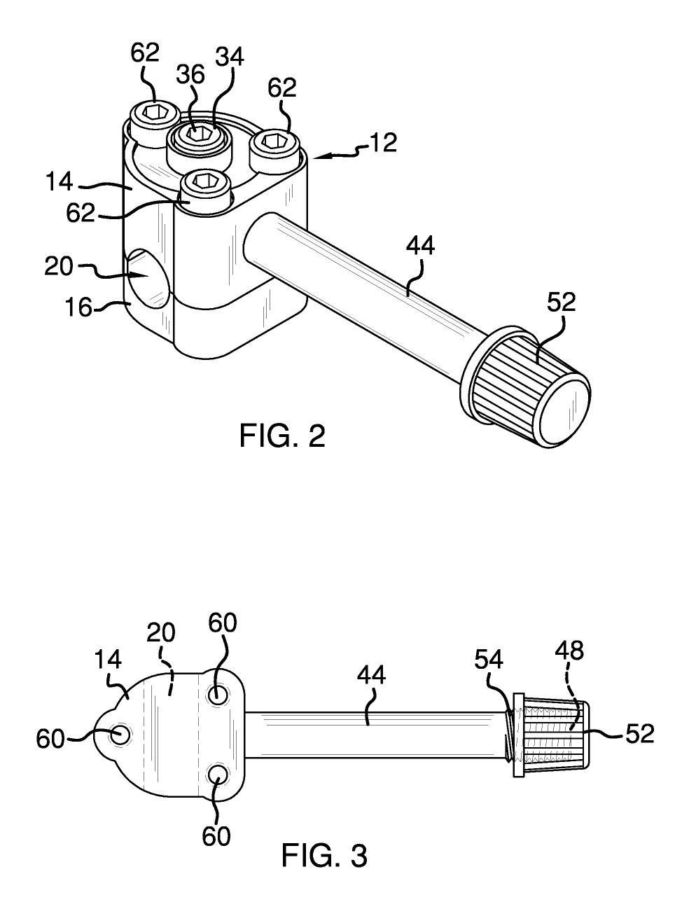

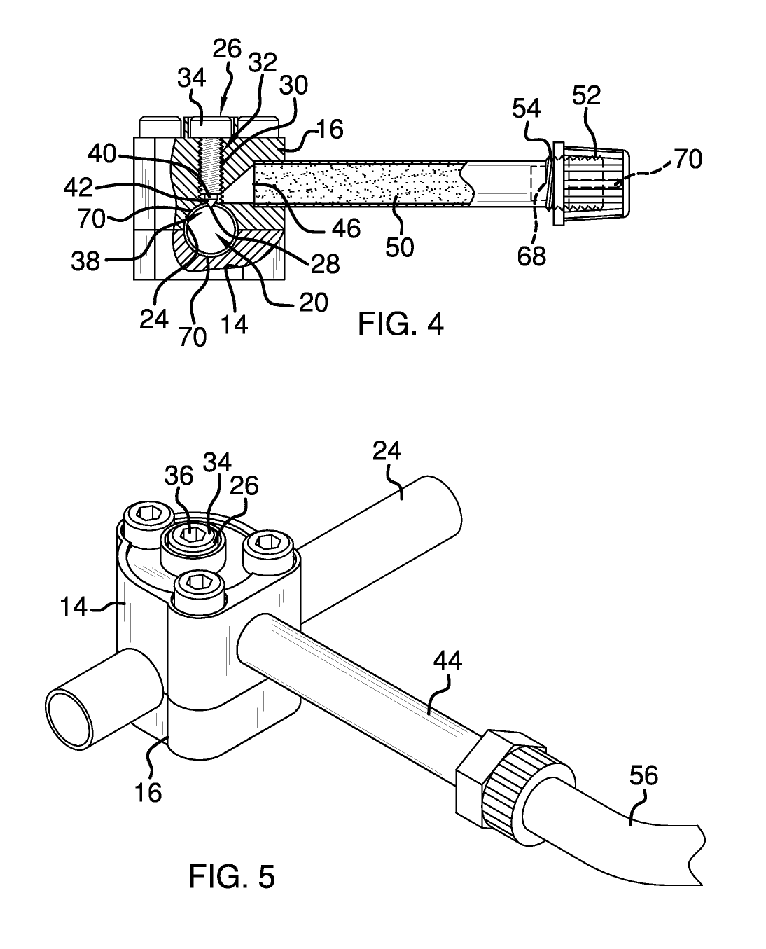

With reference now to the drawings, and in particular to FIGS. 1 through 5 thereof, a new leak locating device embodying the principles and concepts of an embodiment of the disclosure and generally designated by the reference numeral 10 will be described.

As best illustrated in FIGS. 1 through 5, the refrigerant leak locating device 10 generally comprises a housing 12 having a first section 14 and a second section 16. The first section 14 is selectively separable from the second section 16. Each of a pair of channels 18 extends into a respective one of the first section 14 of the housing 12 and the second section 16 of the housing 12. Each channel 18 is defined by a respective wall 70 having a semi-circular transverse shape extending along a length of the channel 18. The channels 18 are aligned defining a conduit 20 through the housing 12 when the first section 14 is coupled to the second section 16. Each of a plurality of fasteners 22 couples the first section 14 of the housing 12 to the second section 16 of the housing 12. The fasteners 22 secure the housing 12 to a refrigerant line 24 such that the refrigerant line 24 extends through the conduit 20 with sufficient tightness to prevent environmental communication between the conduit 20 and the refrigerant line 24. Each fastener 22 may have a threaded distal portion 60 relative to a head 62. Each fastener 22 may extend through a respective hole 64 extending through the first section 14 of the housing 12 to threadedly engage an aperture 66 extending into the second section 16.

A screw 26 is coupled to and extends into the housing 12. The screw 26 has a pointed end 28. The pointed end 28 extends into the conduit 20 when the screw 26 is fully inserted into the housing 12 wherein the pointed end 28 is configured for piercing the refrigerant line 24 positioned in the conduit 20. A main section 30 of a shaft 32 of the screw 26 extends from a head 34 of the screw 26 towards the pointed end 28 of the screw 26. The main section 30 has a substantially constant diameter extending along a length of the main section 30 and threadedly engages the housing 12 such that the screw 26 obstructs environmental communication between the housing 12 and the screw 26. A cavity 36 extends into the head 34 of the screw 26 opposite the pointed end 28. The cavity 36 is configured for receiving a driving tool for facilitating rotation of the screw 26 relative to the housing 12 to selectively extend and retract the pointed end 28 of the screw 26 into and out of the conduit 20. A spike section 38 of the shaft 32 of the screw 26 extends from the main section 30 of the shaft 32 of the screw 26. The spike section 38 has a proximal portion 40 relative to the main section 30 of the shaft 32. The proximal portion 40 has a substantially consistent diameter extending along a length of the proximal portion 40. A diameter of the proximal portion 40 of the spike section 38 is less than a diameter of the main section 30 of the shaft 32 of the screw 26. The spike section 38 also has a distal portion 42 relative to the main section 30 of the shaft 32. The distal portion 42 tapers extending away from the proximal portion 40. The distal portion 42 of the spike section 38 terminates at the pointed end 28 of the screw 26.

A tube 44 is coupled to and extends into the housing 12. The tube 44 has a first end 46 in fluid communication with the conduit 20. A second end 48 of the tube 44 is closed by a valve 68 of the conventional type used in tires or the like. The valve 68 is positioned in spaced relationship to the housing 12. A cap 52 is provided for covering the second end 48 of the tube 44. The cap 52 is selectively couplable to the second end 48 of the tube 44 such that the cap 52 prevents unintended opening of the valve 68 due to pressure on a pin 70 of the valve 68. A dye 50 is positioned in the tube 44 wherein the dye 50 is configured to be introduced into the refrigerant line 24 when the pointed end 28 of the screw 26 pierces the refrigerant line 24. The dye 50 may be a liquid mixing with a refrigerant in the refrigerant line 24. The dye 50 may be provided in a bright or other easily seen color whereby dyed refrigerant escaping through a leak in the refrigerant line 24 is easily seen revealing a location of the leak. The cap 52 may engage threading 54 positioned on the tube 44. The threading 54 extends from the second end 48 of the tube 44 wherein the tube 44 is also configured for being coupled to a hose 56 of the like to open the valve 68 and pressurize the tube 44 facilitating dispensing of the dye 50 from the tube 44 into the refrigerant line 24 positioned in the conduit 20.

In use, the housing 12 is attached to the refrigerant line 24. Prior to piercing the refrigerant line 24 with the pointed end 28 of the screw 26, the hose 56 may be attached to the second end 48 of the tube 44. The screw 26 is rotated to extend the pointed end 28 into the refrigerant line 24 extending through the conduit 20. The dye 50 is urged into the refrigerant line 24 to facilitate visual identification of leaks in the refrigerant line 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A refrigerant leak locating device comprising:
a housing, said housing comprising a first section and a second section, said first section being selectively separable from said second section;
a pair of channels, each of said channels extending into a respective one of said first section of said housing and said second section of said housing, said channels being aligned defining a conduit through said housing when said first section is coupled to said second section;
a screw being coupled to and extending into said housing, said screw having a pointed end, said pointed end extending into said conduit when said screw is fully inserted into said housing wherein said pointed end is configured for piercing a refrigerant line positioned in said conduit;
a tube coupled to and extending into said housing, said tube having a first end being in fluid communication with said conduit; and
a dye positioned in said tube wherein said dye is configured to be introduced into the refrigerant line when said pointed end of said screw pierces the refrigerant line.

2. The device of claim 1, further comprising a plurality of fasteners, said fasteners coupling said first section of said housing to said second section of said housing.

3. The device of claim 1, further comprising:
a second end of said tube being open; and
a cap, said cap being selectively couplable to said second end of said tube such that said cap seals said second end of said tube.

4. The device of claim 3, further comprising threading positioned on said tube, said threading extending from said second end of said tube wherein said tube is configured for being coupled to a hose to pressurize said tube facilitating dispensing of said dye from said tube into the refrigerant line in positioned in said conduit.

5. The device of claim 1, further comprising said dye being a liquid.

6. The device of claim 1, further comprising a cavity extending into a head of said screw opposite said pointed end, said cavity being configured for receiving a driving tool for facilitating rotation of said screw relative to said housing.

7. The device of claim 6, further comprising a main section of a shaft of said screw extending from said head towards said pointed end of said screw, said main section having a substantially constant diameter extending along a length of said main section.

8. The device of claim 7, further comprising a spike section of said shaft of said screw extending from said main section of said shaft of said screw, said spike section having a proximal portion relative to said main section of said shaft, said proximal portion having a consistent diameter extending along a length of said proximal portion.

9. The device of claim 8, further comprising a diameter of said proximal portion of said spike section being less than a diameter of said main section of said shaft of said screw.

10. The device of claim 8, further comprising said spike section having a distal portion relative to said main section of said shaft, said distal portion tapering extending away from said proximal portion, said distal portion of said spike section terminating at said pointed end of said screw.

11. A refrigerant leak locating device comprising:
a housing, said housing comprising a first section and a second section, said first section being selectively separable from said second section;
a plurality of fasteners, said fasteners coupling said first section of said housing to said second section of said housing;
a pair of channels, each of said channels extending into a respective one of said first section of said housing and said second section of said housing, said channels being aligned defining a conduit through said housing when said first section is coupled to said second section;
a screw being coupled to and extending into said housing, said screw having a pointed end, said pointed end extending into said conduit when said screw is fully inserted into said housing wherein said pointed end is configured for piercing a refrigerant line positioned in said conduit;
a main section of a shaft of said screw extending from said head towards said pointed end of said screw, said main section having a substantially constant diameter extending along a length of said main section;
a spike section of said shaft of said screw extending from said main section of said shaft of said screw, said spike section having a proximal portion relative to said main section of said shaft, said proximal portion having a consistent diameter extending along a length of said proximal portion, a diameter of said proximal portion of said spike section being less than a diameter of said main section of said shaft of said screw, said spike section having a distal portion relative to said main section of said shaft, said distal portion tapering extending away from said proximal portion, said distal portion of said spike section terminating at said pointed end of said screw;
a cavity extending into a head of said screw opposite said pointed end, said cavity being configured for receiving a driving tool for facilitating rotation of said screw relative to said housing;
a tube coupled to and extending into said housing, said tube having a first end being in fluid communication with said conduit, a second end of said tube being open;
a dye positioned in said tube wherein said dye is configured to be introduced into the refrigerant line when said pointed end of said screw pierces the refrigerant line, said dye being a liquid;
a cap, said cap being selectively couplable to said second end of said tube such that said cap seals said second end of said tube; and
threading positioned on said tube, said threading extending from said second end of said tube wherein said tube is configured for being coupled to a hose to pressurize said tube facilitating dispensing of said dye from said tube into the refrigerant line in positioned in said conduit.
